(19) United States
(12) Patent Application Publication
(10) Pub. No.: US 2026/0261936 A1
(43) Pub. Date: Sep. 3, 2026

(54) COMMUNICATION APPARATUS

(71) Applicant: CANON KABUSHIKI KAISHA, Tokyo (JP)

(72) Inventor: YOICHI MAEDA, Kanagawa (JP)

(21) Appl. No.: 19/654,210

(22) Filed: Apr. 21, 2026

Related U.S. Application Data
(63) Continuation of application No. PCT/JP2024/037123, filed on Oct. 18, 2024.

(30) Foreign Application Priority Data
Oct. 23, 2023 (JP) 2023-181830

(51) Int. Cl. H04W 36/08; H04W 36/00; H04W 76/20

(52) U.S. Cl. CPC H04W 36/08; H04W 36/0016; H04W 76/20

(57) ABSTRACT

A communication apparatus configured to function as a mobile Integrated Access and Backhaul (IAB) node includes at least one processor, wherein the at least one processor acts as units including a determination unit configured to perform determination processing based on a communication condition, the determination processing including whether to perform migration of a Distributed Unit (DU) function unit, and a first transmission control unit configured to, in a case where the determination unit determines to perform the migration, transmit notification information related to the migration to a connected IAB donor Central Unit (CU).

### CROSS-REFERENCE TO RELATED APPLICATIONS

This application is a Continuation of International Patent Application No. PCT/JP2024/037123, filed October 18, 2024, which claims the benefit of Japanese Patent Application No. 2023-181830, filed October 23, 2023, both of which are hereby incorporated by reference herein in their entirety.

### BACKGROUND

### Field of the Technology

The present disclosure relates to a communication apparatus.

### Description of the Related Art

The Third Generation Partnership Project (3GPP [registered trademark]) has stipulated cellular communication standards. In the 3GPP cellular communication standards (hereinafter also referred to as "3GPP standards"), standardization of Integrated Access and Backhaul (IAB), which integrates an access link and a backhaul link, is underway (see Japanese Unexamined Patent Application Publication (Translation of PCT Application) No. 2019-534625).

In IAB, radio resources used for access links between a base station and user terminals (user equipments [UEs]) are also used for backhaul links. For example, in IAB, radio resources in a millimeter wave band such as the 28-GHz band may be used. By using IAB, relay apparatuses (IAB nodes) can relay communication between a base station apparatus (IAB donor) and terminal apparatuses via wireless links. As a result, area coverage can be expanded at low cost compared to cases where wired lines such as optical fibers are used.

An IAB node includes a Mobile Termination (MT) serving as a connection function unit to a parent node, and a Distributed Unit (DU) serving as a radio connection function unit with UEs and child nodes.

Independent migration of the MT and DU of an IAB node between different donors has also been described (International Patent Publication No. WO 2021/098085).

In the Third Generation Partnership Project (3GPP), it is contemplated to expand coverage areas in urban areas and the like by using a new vehicle-mounted type of relay apparatuses functioning as Integrated Access and Backhaul (IAB) nodes mounted on vehicles (moving bodies) such as buses, trains, and taxis. Hereinafter, such a vehicle-mounted type of relay apparatus will also be referred to as a mobile IAB. A mobile IAB node is also called Mobile Base Station Relay (MBSR).

When using mobile IAB, various issues are considered to arise that cannot be addressed solely by the cellular communication standard specifications stipulated up to Release 17, which assume IAB nodes and fixed base stations predicated on being fixedly installed at certain locations.

For example, the conventional techniques have an issue that there is no mechanism for enabling migration of a Distributed Unit (DU) of a mobile IAB depending on communication conditions.

### SUMMARY

The present disclosure has been achieved in view of at least one of the foregoing issues. According to an aspect, the present disclosure is directed to providing a mechanism that enables migration of a DU depending on communication conditions. According to another aspect, the present disclosure is directed to enhancing the convenience of cellular communications.

According to an aspect of the present disclosure, a communication apparatus configured to function as a mobile Integrated Access and Backhaul (IAB) node includes at least one processor, wherein the at least one processor acts as units including a determination unit configured to perform determination processing based on a communication condition, the determination processing including whether to perform migration of a Distributed Unit (DU) function unit, and a first transmission control unit configured to, in a case where the determination unit determines to perform the migration, transmit notification information related to the migration to a connected IAB donor Central Unit (CU).

Features of the present disclosure will become apparent from the following description of embodiments with reference to the attached drawings.

### BRIEF DESCRIPTION OF THE DRAWINGS

FIG. 1 is a diagram illustrating an example of a communication system.

FIG. 2A is a diagram illustrating a concept (part 1) of an Integrated Access and Backhaul (IAB) protocol stack.

FIG. 2B is a diagram illustrating a concept (part 2) of the IAB protocol stack.

FIG. 3 is a diagram illustrating the format of a Backhaul Adaptation Protocol (BAP) Data Protocol Data Unit (PDU) or packet.

FIG. 4A is a diagram illustrating a hardware configuration of a mobile IAB node.

FIG. 4B is a block diagram (first embodiment) illustrating a configuration example of software functions of the mobile IAB node.

FIG. 5 is a conceptual diagram illustrating an example where the mobile IAB node according to the present embodiment migrates between different IAB donors.

FIG. 6 is a sequence diagram (first embodiment) for describing a procedure for DU migration processing of the mobile IAB node.

FIG. 7 is a diagram (first embodiment) illustrating an example of control in which the mobile IAB node determines DU migration based on a network slice type.

FIG. 8 is a diagram (first embodiment) illustrating an example of control in which the mobile IAB node determines DU migration in the first embodiment.

FIG. 9 is a flowchart (first embodiment) illustrating information collection processing by an IAB donor.

FIG. 10 is a block diagram (third embodiment) illustrating a configuration example of software functions of an IAB donor.

FIG. 11 is a sequence diagram (third embodiment) illustrating an example of control performed by the IAB donor.

FIG. 12 is a flowchart (third embodiment) illustrating an example of the control performed by the IAB donor.

FIG. 13 is a flowchart (third embodiment) illustrating an example of the control performed by the IAB donor.

### DESCRIPTION OF THE EMBODIMENTS

Embodiments will be described in detail below with reference to the attached drawings. In the following description, "numerals " in TS represent the number of the Technical Specification in the Third Generation Partnership Project (3GPP) standards.

### Background of Present Embodiment

The 3GPP is reviewing redundancy between Integrated Access and Backhaul (IAB) donors, and an IAB node called a boundary IAB node can access two different parent nodes connected to two different IAB donors. In such a case, the IAB donors manage respective different IAB topologies (also referred to as IAB networks). A boundary IAB may belong to a single IAB topology, i.e., a single IAB donor for setting and management purposes. Even in such a case, the boundary IAB node can route packets from a first IAB topology managed by a first IAB donor to a second IAB topology managed by a second IAB donor. An advantage of such inter-donor redundancy is that the first IAB donor can perform offloading by routing a portion of its packets through the second IAB topology. This can mitigate congestion issues and overcome radio link failure (RLF) issues that may occur in the first IAB topology.

There are other situations where an IAB node becomes a boundary IAB node. For example, in the case of partial migration of an IAB node decided by an IAB donor, a Mobile Termination (MT) of the IAB node is connected to one parent IAB node belonging to another IAB topology controlled by another IAB donor.

Such a situation can also occur with an IAB node that has recovered via a parent IAB node belonging to another IAB topology due to the occurrence of an RLF. In this case, the migrated IAB node and its potential descendant IAB nodes still belong to the initial IAB topology. Such a partial migration may be referred to as MT migration. To enable traffic routing via another IAB topology, traffic migration needs to be performed after MT migration. In other words, traffic migration needs to be performed so that traffic associated with the boundary IAB node and its descendant IAB nodes is routed to the boundary IAB node (i.e., the migrated IAB node) via another IAB topology. For a fixed IAB node, only a single MT migration is needed. In practice, a backhaul link (defined between two consecutive IAB nodes within a wireless backhaul) may experience radio failure due to fluctuations in radio conditions. For a non-mobile IAB node, this means a temporary situation where the link may recover after some time. There is therefore no need for such a fixed IAB node to perform multiple MT migrations to the same IAB topology or to another IAB topology, whereby transmission and processing of multiple protocol messages can be avoided. For the same reason, there is no need for a fixed node to delegate control of the IAB node to a new IAB donor and migrate the Distributed Unit (DU) of the IAB node. Furthermore, such DU migration, which may be referred to as full migration, also includes handover of user equipments (UEs) served by the migrating mobile IAB node.

In 3GPP, it is contemplated to extend coverage areas in urban areas and the like by using a new vehicle-mounted type of relay apparatuses functioning as IAB nodes mounted on vehicles (moving bodies) such as buses, trains, and taxis. Hereinafter, such a vehicle-mounted type of relay apparatus will also be referred to as a mobile IAB. A mobile IAB or mobile IAB node is also referred to as a Mobile Base Station Relay (MBSR).

When using mobile IABs, various issues are considered to arise that cannot be addressed solely by the cellular communication standard specifications stipulated up to Release 17, which assume IAB nodes and fixed base stations predicated on being fixedly installed at certain locations.

For example, mobile IABs are assumed to be mounted on vehicles and the like, and may therefore have low processing capability compared to conventional fixed IAB donors and the like, due to trade-offs with weight reduction, power consumption costs, etc. Moreover, mobile IABs perform backhaul communication with upper IAB nodes and IAB donors while moving through areas. This results in the characteristic that communication demand changes dynamically with movement, compared to communication conditions in which base stations are fixedly installed to handle UE communication based on predicted communication demand.

Urban environments are typically characterized by the presence of a considerable number of vehicles (for example, public/private passenger transport, goods delivery, and food trucks) and a high density of users. Some of these vehicles (such as buses, trams, and trains) have predictable routes and may be accessed by a large number of UEs. According to 3GPP, equipping such vehicles with vehicle-mounted base stations functioning as mobile relays can provide opportunities to enhance network coverage and connectivity to UEs inside the vehicles as well as UEs in proximity to the vehicles. Such mobile IABs use a Fifth Generation (5G) wireless backhaul (typically IAB) to connect to fixed donor devices. Based on the fixed IAB infrastructure of Releases 16 and 17, 3GPP is currently studying mobile IAB systems and architectures as part of the Release 18 framework to address scenarios focusing on mobile IAB nodes mounted on vehicles. In such scenarios, a mobile IAB node is called Vehicle Mounted Relay (VMR), and provides 5G coverage/capacity to onboard (in-vehicle) and/or surrounding UEs. For a mobile IAB node, it is worth performing multiple MT migrations or DU migrations. The reason is that the mobile IAB node may not reconnect to a parent IAB node belonging to the initial IAB topology for a long time as it moves, or may never reconnect once it moves away from the parent IAB node. Moreover, for flexible IAB network management, decoupling MT and DU migrations is useful. That is, DU migration of an IAB node may occur independently before or after one or more MT migrations of this IAB node. Furthermore, DU migration of an IAB node may target an IAB donor different from that associated with the MT of this IAB node.

MT migration of mobile IAB (mIAB) corresponds to handover (HO) of the MT function unit, and whether MT migration is needed is determined by the IAB donor based on the radio signal strength of nodes neighboring the IAB donor.

However, if MT migration of a mobile IAB node is decided and communication conditions deteriorate due to a change in the connection path between the IAB donor and the DU of the mobile IAB node, there is no mechanism to notify the IAB donor to which the DU is connected of the communication conditions. There is thus an issue that a mobile IAB node takes a long time to detect deterioration in communication conditions with the connected IAB donor central unit (CU), failing to achieve path switching to an appropriate IAB donor CU.

Each of the embodiments described below can solve the foregoing issue, can provide a mechanism that enables DU migration depending on communication conditions, and can enhance the convenience of cellular communication.

### Description of Operation of mIAB Based on 3GPP Specifications

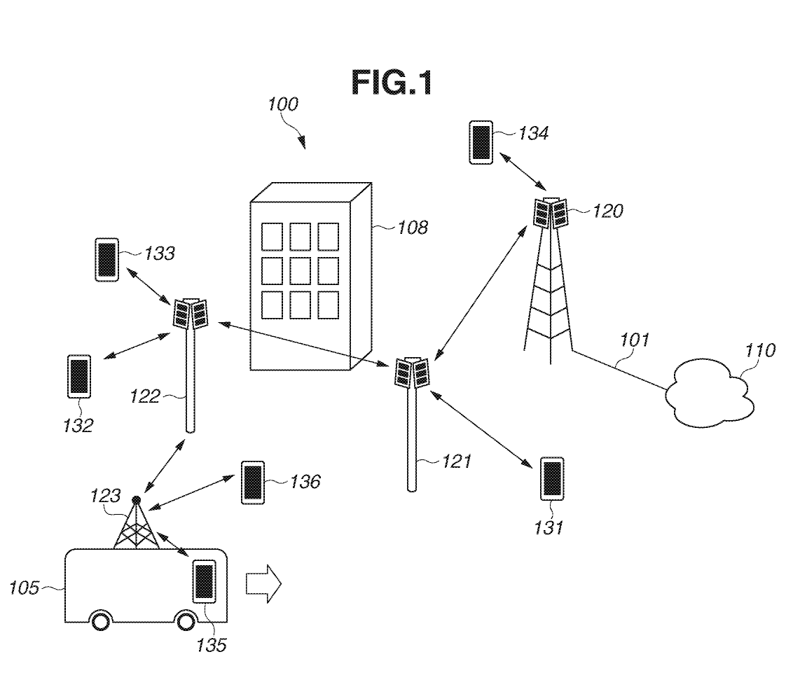

First, FIG. 1 illustrates a mobile wireless communication system, such as a 5G system, including a wireless integrated access and backhaul network that supports a mobile IAB node of a communication system 100.

The communication system 100 includes a plurality of UEs 131, 132, 133, and 134, a core network 110, a main base station 120, and two integrated access and backhaul stations or IAB nodes 121 and 122. The communication system 100 also includes a mobile integrated access and backhaul station (mobile IAB node) 123 mounted on a vehicle 105 (such as a bus, a train, a taxi, or an automobile).

The main base station 120, which is also referred to as an IAB donor 120, is connected to the core network 110 via a wired link 101 (such as an optical fiber or other wired unit). In the present embodiment, the IAB donor 120 is a 5G base station (gNodeB [gNB]) with additional functionality to support IAB functions, as defined in the 3GPP TS 38.300 v 17.2.0 specification. To extend the network coverage of the IAB donor 120 and reach remote UEs 132, 133, and 131, the IAB nodes 121 and 122 are installed by the operator. The IAB nodes 121 and 122 function as relay nodes between the IAB donor 120 and the UEs 132 and 133. The IAB nodes 121 and 122 thereby reduce reachability issues resulting from the presence of a building 108 that obstructs radio propagation and by extension direct connection and further communication between UEs and the IAB donor 120. This particularly applies when communication between the IAB donor 120 and the UEs 132 and 133 operates at millimeter-wave frequencies, which are highly sensitive to shadowing phenomena. The IAB donor 120 also serves the directly connected UE 134.

The mobile IAB node 123 is also referred to as a mobile IAB node, and is mounted on the vehicle 105 to extend the network coverage and capacity. Radio signals of the IAB donor 120 can reach not only on-board UEs such as a remote UE 135, but also surrounding UEs near the IAB node 123 such as a UE 136. The IAB donor 120 and the IAB nodes 121, 122, and 123 thus form a backhaul network, IAB network, or IAB topology accommodating the UEs 131 to 136. The terms IAB network and IAB topology will hereinafter be synonymously used. IAB specifications are defined in several 3GPP standard documents as follows:
1) TS 38.300 Radio Access Network (RAN) Architecture (V 17.2.0)
2) TS 38.321 Medium Access Control (MAC) Protocol (V 17.2.0)
3) TS 38.331 Radio Resource Control (RRC) Protocol (V 17.2.0)
4) TS 38.340 Backhaul Adaptation Protocol Layer (V 17.2.0)
5) TS 38.401 RAN Architecture (V 17.2.0)
6) TS 38.423 Xn Application Protocol (V 17.2.0)
7) TS 38.473 F1 Application Protocol (V 17.2.0)

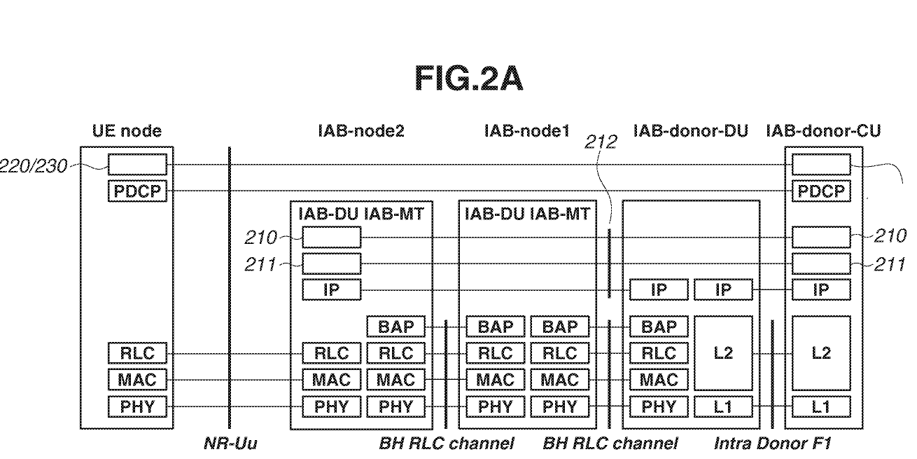

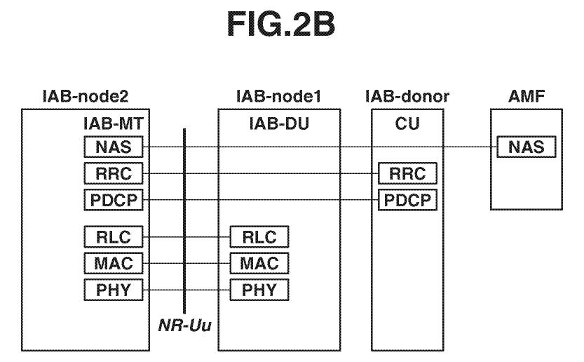

The IAB donor 120 and the IAB nodes 121, 122, and 123 are each connected to the UEs 131 to 136, and are therefore regarded as access IAB nodes for the UEs. The IAB donor 120 is a logical node that provides a New Radio (NR)-based wireless backhaul, and includes a CU (CU or gNB-CU function) and a donor DU (DU or gNB-DU function) connected to the CU. An IAB donor CU or donor CU (hereinafter, also referred to as an "IAB donor CU") hosts upper layer protocols such as Packet Data Convergence Protocol (PDCP) and RRC protocols for controlling the operation of one or more DUs. PDCP is an abbreviation for Packet Data Convergence Protocol, and RRC is an abbreviation for Radio Resource Control. One or more IAB donor DUs each include lower layer protocols such as Radio Link Control (RLC), Medium Access Control (MAC), and physical layer protocols. The IAB donor CU and the IAB donor DU may be located remotely from each other or within the same physical device. The gNB-DU function is defined in 3GPP TS 38.401. The gNB-DU is intended to terminate an NR access interface to UEs and next-hop IAB nodes, and to terminate an F1 protocol with the IAB donor gNB-CU function as illustrated in FIGS. 2A and 2B to be described below. IAB nodes that may serve a plurality of radio sectors are wirelessly backhauled to the IAB donor 120 via one or more hops over one or more intermediate IAB nodes. These form a directed acyclic graph (DAG) topology rooted at the IAB donor 120.

Each IAB node includes an IAB-DU and an IAB-MT. The gNB-DU function on an IAB node, also referred to as an IAB-DU, enables downstream (UE-direction) connection to the next-hop IAB or UEs. The IAB-MT function includes, for example, physical layer, Layer 2, RRC, and Non-Access Stratum (NAS) functions for connecting to the gNB-DU of an upstream IAB node. Upstream IAB nodes include the IAB donor 120. The IAB-MT function connects to the IAB donor gNB-CU, and also connects to the core network 110 for initialization, registration, configuration, and the like. In this DAG topology, an adjacent node on the IAB-DU interface is referred to as a child node, and an adjacent node on the IAB-MT interface is referred to as a parent node. The direction toward a child node is further referred to as downstream, and the direction toward a parent node is referred to as upstream. The IAB donor 120 (e.g., the IAB donor CU) performs centralized management of resources, topologies, and routes across the entire IAB topology. This includes configuring IAB nodes based on the network topology, for example, to perform appropriate routing of data packets.

FIGS. 2A and 2B schematically illustrate stacks of several protocol layers related to IAB operation. An F1 interface supports exchange of signaling information (for example, control traffic) between endpoints and data transmission (for example, user traffic transmission) to the respective endpoints. From a logical viewpoint, the F1 interface serves as a point-to-point interface between endpoints.

In 5G, F1-control plane (F1-C) is a functional interface between the IAB donor CU and IAB node DUs and between the IAB donor CU and the IAB donor DU in a control plane (C-Plane). F1-user plane (F1-U) is a functional interface between the same units in a user plane (U-Plane). F1-U and F1-C are denoted by the reference numeral 212 in FIG. 2A. In this example, F1-U and F1-C communications are transferred over two backhaul hops (from the IAB donor to IAB-node1, and further from IAB-node1 to IAB-node2).

In the U-plane, boxes 210 at the IAB donor CU and the IAB node DU refer to a General Packet Radio Service (GPRS) Tunnelling Protocol - User Plane (GTP-U) layer, and boxes 211 refer to a User Datagram Protocol (UDP) layer. GTP-U is an abbreviation for GPRS Tunneling Protocol User Plane. A GTP-U tunnel is used to transfer encapsulated Protocol Data Units (PDUs) and signaling messages between a specific pair of GTP-U tunnel endpoints (for details, see 3GPP TS 29.281). PDU is an abbreviation for Protocol Data Unit. Here, the boxes 210 at the IAB donor CU and the IAB node DU are illustrated. UDP is a transport layer protocol that provides a best-effort datagram service and is suitable for use with the Internet Protocol (IP) protocol.

In the C-plane, the boxes 210 refer to an F1 Application Protocol (F1-AP) layer. The boxes 211 refer to a Stream Control Transmission Protocol (SCTP) layer. The F1-AP (defined in 3GPP TS 38.473 and TS 38.401) provides signaling services between the IAB donor CU and the IAB node DU, or between UE-related services. These services include initialization and configuration, and the SCTP layer provides reliable sequential transfer of messages with congestion control.

As defined in 3GPP TS 38.401, F1-U and F1-C depend on the IP transport layer between the IAB donor CU and the IAB node DU. Transport between the IAB donor DU and the IAB donor CU is implemented as follows. When the IAB donor CU is remote from the IAB donor DU, the IP transport layer over various media such as wires and optical fibers is used, or virtual instantiation of the IAB donor CU and the IAB donor DU on the same physical machine is used locally. IAB-specific transport between the IAB donor CU and the IAB donor DU is defined in 3GPP TS 38.401.

In FIG. 2A, L1 and L2 support the transport layer and the physical layer suitable for the medium in use, respectively. The IP layer can also be used for non-F1 traffic such as operation, administration, and maintenance traffic. In wireless backhaul, the IP layer itself is transferred via a Backhaul Adaptation Protocol (BAP) sublayer, enabling routing over multiple hops. The BAP sublayer is specified in TS 38.340.

IAB-DU IP traffic is routed through wireless backhaul via the BAP sublayer. Upper layer packets downstream are encapsulated by the BAP sublayer of the IAB donor DU, whereby BAP packets, PDUs, or data packets are formed. The BAP packets are routed by the BAP layer or entity of an intermediate IAB node (and corresponding BAP entities of the IAB-DU and IAB-MT). The BAP packets are eventually decapsulated by the BAP sublayer of the destination IAB node (which may be an access IAB node if upper layer packets in the BAP packets are destined for a UE).

Upper layer packets upstream are encapsulated by the BAP sublayer of the originating IAB node (an access IAB node if the upper layer packets are transmitted from a UE).

BAP packets, data units (PDUs), or data packets are thereby formed. The BAP packets are routed by the BAP layer of an intermediate IAB node (and corresponding BAP entities of the IAB-DU and IAB-MT). The BAP packets are eventually decapsulated by the BAP sublayer of the IAB donor DU.

In the BAP sublayer, packets are routed based on a BAP routing identifier (ID). The BAP routing ID is transmitted in the BAP header of BAP packets, and is set by the BAP sublayer of the originating IAB donor DU or the originating IAB node.

FIG. 2B is from 3GPP TS 38.300 v 17.2.0 and illustrates the protocol stack for supporting RRC and NAS connections of the IAB-MT. The NAS protocol handles messages between the core network (CN) and a UE or an IAB node. For example, the NAS protocol manages the establishment of communication sessions and maintains communication with a mobile IAB node or UE. 5G NAS is described in 3GPP TS 24.501. The 5G Core Access and Mobility Management Function (AMF) is a function within the CN that receives all connection- and session-related information from UEs connected to the IAB node, as well as similar information about the IAB node. AMF is an abbreviation for Access and Mobility Management Function, and is responsible only for handling connection and mobility management tasks. The IAB-MT establishes signals for radio bearers Signaling Radio Bearers (SRBs) (bearers that carry RRC and NAS messages) with the IAB donor CU. These SRBs are transferred between the IAB-MT and its parent node via an NR-Uu interface.

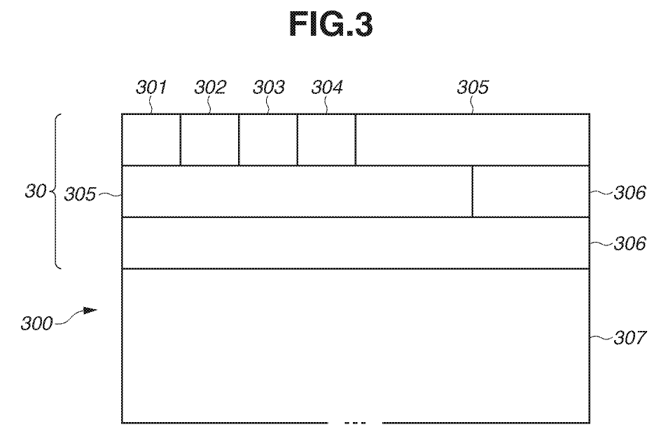

FIG. 3 illustrates a BAP Data PDU or packet format 300. This is specified in section 6.2 of 3GPP TS 38.340 Release 17.2.0. A payload section 307 is typically an IP packet, and a header 30 includes fields 301 to 306. The field 301, named Data/Control (D/C) field, contains a Boolean value indicating whether the corresponding BAP packet is a BAP data packet or a BAP control packet. The fields 301 to 304 are 1-bit reserved fields and are desirably set to 0 (ignored by the receiving side). The fields 305 and 306 collectively indicate the BAP Routing ID of the BAP packet. The BAP Address field 305 (also called the DESTINATION field) is the leftmost 10 bits, and the BAP Path ID field 306 (also called the PATH field) is the rightmost 10 bits. The field 305 carries the BAP address (on the BAP sublayer) of the destination IAB node or IAB donor DU of the BAP packet. For routing purposes, each IAB node or IAB donor DU in an IAB network is configured by the IAB donor CU of the IAB network with a specified unique BAP address. The field 306 contains a path ID that identifies the routing path that the BAP packet needs to traverse to this destination in the IAB topology. For routing, the IAB donor CU configures routing paths with path IDs at IAB nodes in the IAB network.

The BAP header is added to a packet upon arrival at the BAP layer from an upper layer, and removed by the BAP layer upon reaching the destination node. Selection of the BAP routing ID of a packet is configured by the IAB donor CU. For example, in the case of downstream transmission, a BAP packet is generated by the IAB donor DU. In the case of upstream transmission, a BAP packet is generated by the originating side (the access IAB node if the upper layer packet is transmitted from the UE). A BAP header with a BAP routing ID is constructed by the node based on a configuration table defined in 3GPP TS 38.340. This table is called the Downlink Traffic to Routing ID Mapping Configuration table for an IAB donor DU, or the Uplink Traffic to Routing ID Mapping Configuration table for an originating IAB node. At a relaying IAB node, the BAP header fields are already specified in the BAP packet to be forwarded.

To forward messages over the 5G Next Generation (NG) radio medium, three additional sublayers (RLC, MAC, and physical [PHY]) are implemented at each IAB node below the BAP sublayer. The RLC sublayer is responsible for segmentation or reassembly of packets. It is also responsible for retransmission requests for missing packets. The RLC layer is further described in TS 38.322. The MAC protocol sublayer is responsible for selection of transmission formats available for user data, and for mapping between logical channels and transport channels. MAC also handles part of the Hybrid Automated Repetition request scheme. The MAC layer is detailed in TS 38.321. On the transmitting side, MAC encapsulates data packets issued from RLC and adds a header that conveys information necessary for MAC functions. On the receiving side, MAC decapsulates data packets issued from the PHY layer, removes the header, and delivers the remaining data to RLC. The PHY layer provides an electrical interface to the transmission medium by converting a stream of information into a physical modulated signal and modulating a carrier frequency on the emitter side. On the receiving side, the PHY layer converts the physical modulated signal into a stream of information. The PHY layer is described in TS 38.201, TS 38.211, TS 38.212, TS 38.213, and TS 38.214.

To pass messages to the U- or C-Plane, two sublayers are used at the UE and IAB donor CU. Specifically, the PDCP sublayer and either a Service Data Adaptation Protocol (SDAP) sublayer for U-Plane communication or the RRC sublayer for C-Plane communication are used as the two sublayers.

The PDCP sublayer is described in 3GPP TS 38.323. The PDCP sublayer handles IP header compression/decompression, ciphering/deciphering, and if needed, data packet integrity. Packets are mandatorily numbered on the transmitting side and reordered on the receiving side.

An SDAP sublayer 220 for the U-Plane is described in TS 38.324 and handles Quality of Service. On the UE side, the SDAP sublayer 220 exchanges payload data with user applications (audio, video, etc.).

On the IAB donor CU side, the SDAP sublayer exchanges data with the CN 110 (Internet traffic, cloud, etc.).

An RRC sublayer 230 for the C-Plane is described in TS 38.331 and handles configuration of protocol entities of the U-Plane protocol stack. In particular, the RRC sublayer 230 is responsible for broadcasting information necessary for the UE to communicate with a cell. This includes paging message transmission, connection management (such as bearer configuration), and mobility functions (measurement configuration and reporting).

The interfaces between nodes (both C-Plane [CP] and U-Plane [UP]) using the PDCP, RLC, MAC, and PHY layers refer to NR-Uu. This is primarily an interface with UEs.

The interfaces between nodes (both CP and UP) using the BAP, RLC, MAC, and PHY layers are called the Backhaul RLC Channel, and primarily used for inter-IAB node interfaces.

NR-Uu is the interface between UEs and a radio access network (IAB node).

### Hardware Configuration

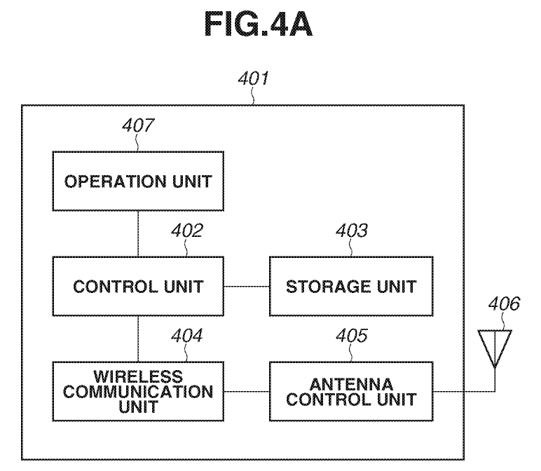

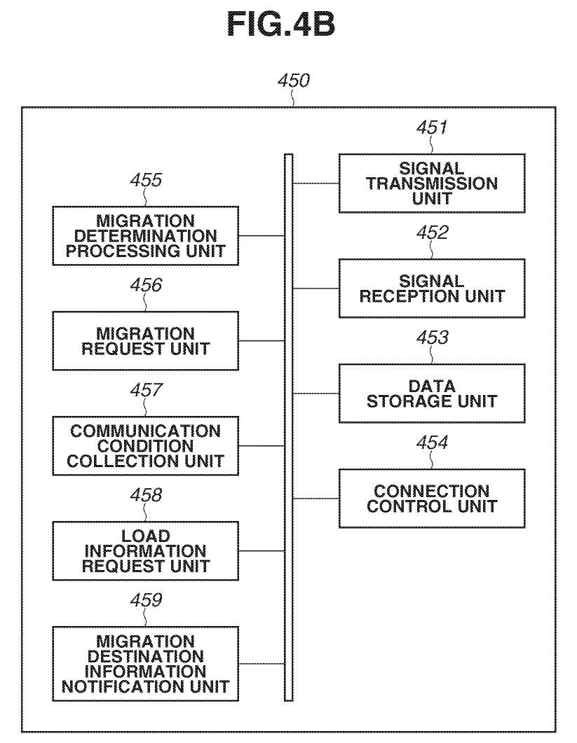

A hardware configuration 401 of the IAB node 123 will be described with reference to FIG. 4A. FIG. 4A is a block diagram for describing an example of the hardware configuration 401 of the IAB node 123.

The hardware configuration 401 of the IAB node 123 includes a control unit 402, a storage unit 403, a wireless communication unit 404, an antenna control unit 405, an antenna 406, and an operation unit 407. The antenna 406 is assumed to be, but not limited to, a phased array antenna.

The storage unit 403 includes one or more memories such as a read-only memory (ROM) and a random access memory (RAM). The storage unit 403 stores computer programs for performing various operations to be described below, communication parameters for wireless communication, management information about UEs connected to the IAB node, etc. The storage unit 403 also functions as a temporary storage area (work area) of data for the IAB node to transfer to UEs via the IAB donor and/or the CN.

Aside from memories such as ROM and RAM, storage media such as a hard disk and a nonvolatile memory may be used as the storage unit 403. The storage unit 403 may include a plurality of memories.

The control unit 402 includes, for example, one or more processors such as a central processing unit (CPU) and a microprocessing unit (MPU), and controls the entire IAB node 123 by executing computer programs loaded into the RAM that is the storage unit 403. The control unit 402 may control the entire IAB node 123 through cooperation of the computer programs stored in the storage unit 403 and an operating system (OS).

Processing described in the following flowcharts for the control unit 402 to perform is also implemented by executing computer programs loaded into the RAM that is the storage unit 403. Alternatively, the processing described in the following flowcharts may be implemented using hardware circuits such as an application-specific integrated circuit (ASIC) and a field-programmable gate array (FPGA). The processing described in the following flowcharts may also be implemented through cooperation of hardware circuits and processors such as a CPU and an MPU.

The wireless communication unit 404 is a module that performs transmission and reception of cellular communication such as Long Term Evolution (LTE) and 5G NR compliant with the 3GPP standards, in cooperation with the control unit 402, the antenna control unit 405, and the antenna 406. The present embodiment deals with a case where the communication unit 404 supports wireless communication compliant with LTE or 5G NR. However, this is not restrictive. For example, wireless communication compliant with the Sixth Generation (6G) and Beyond 5G, which are successor standards to 5G NR, may be supported. The wireless communication unit 404 has a measurement function of measuring communication conditions with UEs and base stations.

The antenna control unit 405 controls the directivity of the antenna 406 to transmit wireless signals generated by the wireless communication unit 404 to UEs and receive wireless signals transmitted from UEs and deliver them to the wireless communication unit 404, using techniques such as beamforming and multi-input multi-output (MIMO).

The operation unit 407 includes a touchscreen capable of detecting a user's touch operations, and a display panel that displays various screens. The operation unit 407 functions as a display unit that displays information and an acceptance unit that accepts user instructions. The control unit 402 displays a setting screen and the like for configuring various settings of the IAB node in cooperation with the operation unit 407. The user can input desired operation instructions to the IAB node 123 by making touch operations on the operation unit 407, using a finger or other objects. The display unit may be an external display device separate from the hardware configuration 401 of the IAB node 123. The acceptance unit may be an input device such as a keyboard and a mouse.

The IAB donor 120 and the IAB nodes 121 and 122 have a hardware configuration similar to that of the IAB node 123, and a description thereof will thus be omitted. As described in FIG. 2A, the IAB donor 120 includes the IAB donor DU and the IAB donor CU. The IAB donor DU and the IAB donor CU may be implemented by separate pieces of hardware. In such a case, the IAB donor DU and the IAB donor CU that are separate pieces of hardware may be communicatively connected via an optical fiber or other network. The connection method of the DU and CU here is not limited thereto.

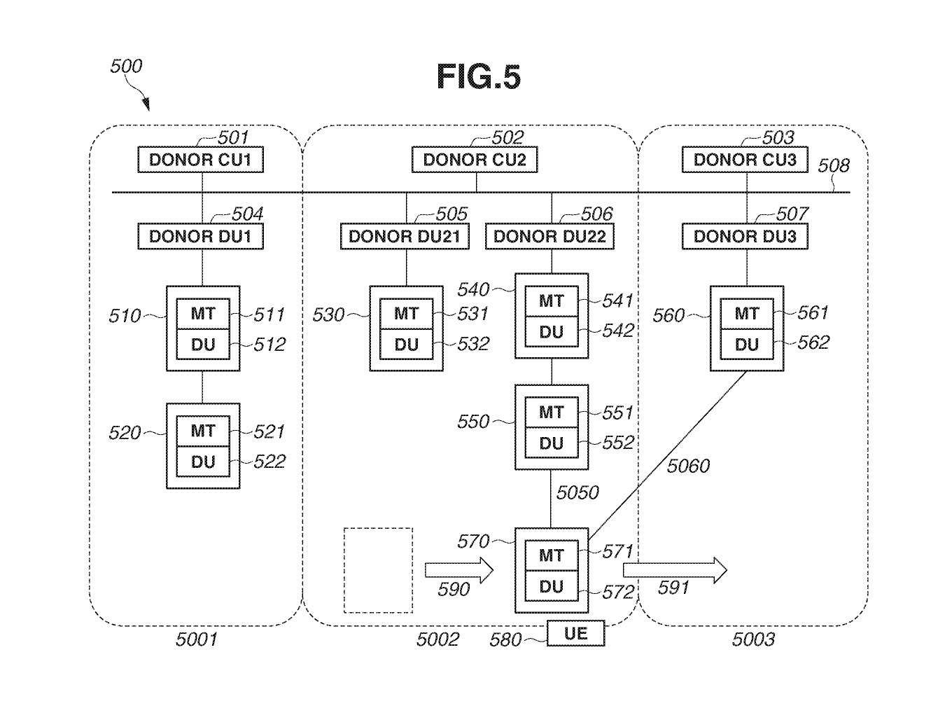

FIG. 4B is a block diagram illustrating a configuration example of software functions 450 of the mobile IAB node (see a mobile IAB node 570 in FIG. 5).

The software functions 450 of the mobile IAB node include a signal transmission unit 451, a signal reception unit 452, a data storage unit 453, a connection control unit 454, and a migration determination processing unit 455. The software functions 450 also include a migration request unit 456, a communication condition collection unit 457, a load information request unit 458, and a migration destination information notification unit 459. The functions of the respective blocks illustrated in FIG. 4B can be implemented by the control unit 402 executing control programs stored in the storage unit 403 in the hardware configuration illustrated in FIG. 4A.

The signal transmission unit 451 and the signal reception unit 452 control the wireless communication unit 404 to transmit and receive wireless signals to/from the IAB donor or other IAB nodes and UEs. The signal transmission unit 451 and the signal reception unit 452 perform transmission and reception of wireless signals compliant with the 3GPP standards such as the LTE standard or the 5G standard.

In the present embodiment, with the mobile IAB node connected to the IAB donor CU, the signal reception unit 452 receives an HO request for the MT function unit from the connected IAB donor CU.

The data storage unit 453 retains various programs and various types of data (various types of information) by storing them in the storage unit 403.

The connection control unit 454 performs processing related to IAB network connection, such as transmission and reception of Radio Resource Control (RRC) messages to/from the IAB donor CU.

The migration determination processing unit 455 performs DU function unit migration determination processing based on the communication conditions. The DU function unit is controlled and configured by the IAB donor using F1-AP messages defined in 3GPP TS 38.473. The communication conditions may be those related to the own station, for example. In the present embodiment, the communication conditions are determined based on various types of information (to be described below) collected and acquired by the communication condition collection unit 457 and the load information request unit 458 to be described below. In a modification, the communication conditions may be determined based on information (to be described below) obtained via either one of the communication condition collection unit 457 and the load information request unit 458 to be described below. The DU function unit migration determination processing by the migration determination processing unit 455 includes determination processing as to whether to migrate the DU function unit. The DU function unit migration determination processing by the migration determination processing unit 455 may include processing for determining the migration destination of the DU function unit in addition to the determination processing as to whether to migrate the DU function unit.

The determination processing by the migration determination processing unit 455 may be performed with the reception of the HO request (HO request for the MT function unit from the connected IAB donor CU) by the signal reception unit 452 as a trigger. Further details of the determination processing by the migration determination processing unit 455 will be described below.

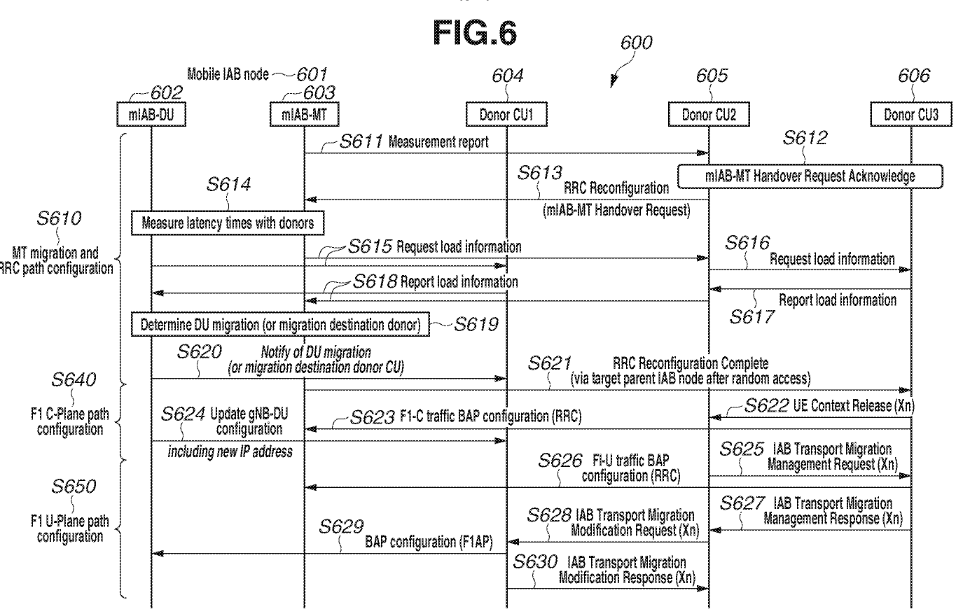

The migration request unit 456 issues a DU function unit migration request when the migration determination processing unit 455 determines to migrate the DU function unit under a specific condition. The specific condition corresponds to where the IAB donor to which the MT function unit is connected and the IAB donor to which the DU function unit is connected are different. In other words, the specific condition corresponds to where the IAB donor establishing the RRC connection and the IAB donor establishing the F1 interface are different. The migration request unit 456 may transmit the DU function unit migration request (an example of notification information) to the IAB donor CU to which the DU function unit is connected (an F1 terminating donor CU 604 in FIG. 6 to be described below). Here, the DU function unit migration request may include information indicating the migration destination of the DU function unit. In another embodiment, other IAB donor CUs (for example, a donor CU 605 in FIG. 6 to be described below) may be included as a notification destination of the migration request in addition to the IAB donor CU to which the DU function unit is connected (F1 terminating donor CU 604 in FIG. 6 to be described below). Further details of the migration request will be described below.

The communication condition collection unit 457 collects communication condition information including at least one of a latency time related to communication with the connected IAB donor CU and a network slice type requested by a UE accessing the own apparatus. The latency time may be a value calculated from a ping value, the number of MT migrations, or the like. Network slice types include types such as low latency (Ultra-Reliable and Low Latency Communications [URLLC]), high speed, high capacity (enhanced Mobile BroadBand [eMBB]), and massive connections (massive Internet of Things [MIoT]). URLLC is an abbreviation for Ultra-Reliable and Low Latency Communications, and MIoT is an abbreviation for Massive Internet of Things. eMBB is an abbreviation for enhanced Mobile BroadBand. Further details of the communication condition information will be described below.

The load information request unit 458 requests load information about the connected IAB donor CU from the connected IAB donor CU. The load information may include free buffer capacity and the number of connected UEs. Aside from the load information about the connected IAB donor CU, the load information request unit 458 may also request load information about other IAB donor CUs neighboring the connected IAB donor CU.

The load information may be requested using an RRC message. In such a case, the RRC Reconfiguration or RRC Setup message format defined in TS 38.331 section 6.2.2 may be used. Here, a "donor CU load information request" field is added to the reserved area "nonCriticalExtension" in the format. Further details of the load information will be described below.

The migration destination information notification unit 459, when migrating the DU function unit based on the foregoing migration request, notifies the connected (F1-connected) IAB donor CU of the ID of the IAB donor CU that is the migration destination. Such a notification may be implemented using an F1-AP message. In such a case, for example, the F1 message gNB-DU CONFIGURATION UPDATE specified in TS 38.473 V 17.2.0 section 9.2.1.7 may be used. The connected IAB donor CU can thereby acquire the ID of the migration destination IAB donor CU. Further details of the ID of the migration destination IAB donor CU will be described below.

### Example of Operation Underlying First Embodiment

FIG. 5 illustrates an example of an IAB communication system (or IAB network system) 500 that can implement the present embodiment. In one example implementation, radio links (backhaul [BH] radio links) between IAB nodes and between an IAB node and an IAB donor DU operate in a millimeter-wave frequency band (30 GHz or higher), which is highly sensitive to radio channel disturbances. Since an IAB network is also referred to as an IAB topology or simply a topology, the terms IAB network and IAB topology are synonymously used in the present embodiment. The IAB communication system 500 includes three IAB topologies 5001, 5002, and 5003. The IAB topologies 5001, 5002, and 5003 each include a plurality of IAB nodes and an IAB donor CU for controlling or managing the plurality of IAB nodes. As the plurality of IAB nodes, for example, a set of IAB nodes may include a plurality of IAB nodes or at least one IAB node. The set of IAB nodes may include one or more IAB nodes, such as an originating IAB node that generates BAP packets and an intermediate IAB node. Each IAB node communicates with at least one other IAB node via a wireless backhaul (BH) link.

While FIG. 5 illustrates the three IAB topologies 5001, 5002, and 5003, the present embodiment is not limited to three IAB topologies. More specifically, the present embodiment can be implemented as an IAB communication system including two or more IAB topologies, with each topology including a set of IAB nodes and an IAB donor CU. As described above, each IAB node includes an MT function unit and a DU function unit. The MT function unit is controlled and configured by the IAB donor using RRC messages defined in 3GPP TS 38.331. For example, an IAB node 510 includes an MT 511 and a DU unit 512.

The IAB topology 5001 includes an IAB donor CU 501 (labeled as donor CU1 in FIG. 5) and its associated IAB donor DU 504 (labeled as donor DU1 in FIG. 5). The IAB topology 5001 also includes a plurality of IAB nodes 510 and 520.

The IAB topology 5002 includes an IAB donor CU 502 (labeled as donor CU2 in FIG. 5) and its associated IAB donor DUs. The IAB topology 5002 includes an IAB donor DU 505 (labeled as donor DU21 in FIG. 5) and an IAB donor DU 506 (labeled as donor DU22 in FIG. 5). The IAB topology 5002 also includes a plurality of IAB nodes 530, 540, and 550, and an IAB node 570. All the IAB nodes can function as access nodes that serve UEs, like a UE 580 served by the mobile IAB node 570. The IAB topology 5002 is transparent to the UE 580 that connects to the donor CU 502 via a DU function unit 572 of the mobile IAB node 570. While FIG. 5 illustrates only one UE 580, multiple UEs are connected to the network nodes of the IAB communication system 500.

The IAB topology 5003 includes an IAB donor CU 503 (labeled as donor CU3 in FIG. 5), its associated IAB donor DU 507 (labeled as donor DU3 in FIG. 5), and an IAB node 560.

A wired backhaul IP network interconnects the IAB donor CUs 501 to 503 and the IAB donor DUs 504 to 507 via a wired backhaul 508. For example, this wired backhaul 508 is constituted by optical fiber cables.

The IAB donor CU 501, the IAB donor DU 504, and the IAB nodes 510 and 520 are part of the IAB topology 5001, and are configured and managed or controlled by the IAB donor CU 501.

The IAB donor CU 502, the IAB donor DUs 505 and 506, and the IAB nodes 530, 540, and 550 are part of the same IAB network or IAB topology 5002, and are configured and managed or controlled by the IAB donor CU 502.

The IAB donor CU 503, the IAB donor DU 507, and the IAB node 560 are part of the same IAB topology 5003, and are configured and managed or controlled by the IAB donor CU 503.

IAB node DUs and IAB donor DUs support wireless communication within respective coverage areas called cells. In other words, IAB node DUs and IAB donor DUs are associated with respective cells. Wireless communication devices located in a cell refer to UEs and other IAB nodes. To communicate with other devices (for example, other UEs, IAB nodes, and servers providing access to the Internet), a wireless communication device in a cell may establish a communication link with a node serving the cell. Examples of the node serving a cell include an IAB node DU and an IAB donor DU.

Suppose that the mobile IAB node 570 initially has a single parent IAB node 520 and belongs to the IAB topology 5001 controlled by the IAB donor CU 501. In such a case, the IAB donor CU 501 operates as an F1 terminating donor CU (also referred to as an F1 terminating IAB donor CU or F1 donor CU). When the mobile IAB node 570 moves, the mobile IAB node 570 may be able to establish a wireless BH link with the IAB node 530, considering its proximity to the IAB topology 5002. For example, if the mobile IAB node 570 is located at the position indicated by the dotted line in FIG. 5, the mobile IAB node 570 may be able to establish a wireless BH link with the IAB node 530. Such a BH link is available for stationary IAB nodes, but a mobile IAB node such as the IAB node 570 is highly likely to move toward the IAB topology 5003 (indicated by arrow 590 and 591 in FIG. 5), for example.

The F1 donor CU 501 then decides to migrate the MT function unit 571 of the IAB node 570 to the IAB topology controlled by the IAB donor CU 502 that has become a non-F1 terminating donor CU for the IAB node 570. In other words, the MT function unit 571 of the IAB node 570 is migrated to the parent IAB node 530. Here, the IAB donor CU 502 serves as a non-F1 terminating donor CU, and is also referred to as a non-F1 terminating IAB donor CU or non-F1 donor CU. For this purpose, the F1 donor CU 501 starts an inter-IAB donor CU topology adaptation procedure. The inter-IAB donor CU topology adaptation procedure is described in TS 38.401 V 17.2.0 section 8.17.3.1 or section 8.17.3.2 (when the IAB node 570 has descendant IAB nodes). As a result, the RRC connection is switched from the donor CU 501 to the donor CU 502 while the IAB node 570 still belongs to the IAB topology 5001 and maintains the F1 connection with the donor CU 501. The IAB donor CU 501 then may request migration of backhaul traffic (such as user traffic and control traffic) associated with the IAB node 570 to the IAB topology 5002. This request is issued via the IAB donor DU 505. In such a case, the IAB donor CU 501 triggers an IAB transport migration management procedure specified in TS 38.423 V 17.2.0 section 8.5.2. In an IAB communication system, all traffic communicated over backhaul links uses the F1 interface (F1-C or F1-U) between the IAB donor CU and IAB node DUs. Therefore, offloaded or migrated traffic or backhaul traffic is F1 traffic, in which control traffic and user traffic can be included.

While the mobile IAB node 570 is still moving in the direction indicated by the arrow 590, the MT function unit 571 of the IAB node 570 is migrated to the parent IAB node 550 by the non-F1 donor CU 502. Here, a backhaul link 5050 between the IAB nodes 550 and 570 is used. For this purpose, the non-F1 donor CU 502 applies an intra-CU topology adaptation procedure described in TS 38.401 V 17.2.0 section 8.2.3.1 (or section 8.17.3.2). As a result, a successive MT migration (or another MT migration to another IAB node) of the IAB node 570 with a new single parent IAB node 550 occurs. Note that the IAB node 570 still maintains the F1 connection with the IAB donor CU 501 and the RRC connection with the IAB donor CU 502.

The IAB donor CU 501, after notified to route the F1 traffic associated with IAB node 570 using the IAB donor DU 506 instead of the IAB donor DU 505, may operate as follows. The IAB donor CU 501 may request the IAB node 570 to migrate the traffic associated with the IAB node 570 to the IAB topology 5002. Here, the IAB donor CU 501 triggers an IAB transport migration management procedure specified in TS 38.423 V 17.2.0 section 8.5.2. The IAB node 570 then may move further toward the IAB topology 5003 controlled by the IAB donor CU 503.

In such a case, the IAB node 570 can reach a position where a backhaul link 5060 with the IAB node 560 may have quality higher than that of the backhaul link 5050 with the IAB node 550. Reaching such a position, the IAB donor CU 502 can apply an inter-CU topology adaptation procedure described in TS 38.401 V 17.2.0 section 8.17.3.1 or 8.17.3.2. Even after this successive MT migration, the DU function unit 572 of the IAB node 570 belongs to the IAB topology 5001 and maintains the F1 connection with the IAB donor CU 501. Meanwhile, with the RRC connection switched to that with the IAB donor CU 503, the IAB donor CU 503 becomes a non-F1 terminating donor CU. Note that the IAB donor CU 501 is notified of the new non-F1 donor CU 503 for the IAB node 570 and the new IAB donor DU 507. This notification is intended to redirect offloaded traffic via the IAB donor DU 507 rather than the IAB donor DU 506. Examples of the offloaded traffic include F1 traffic, control, and user traffic.

In all the foregoing MT migration cases, the UE 580 remains connected to the IAB donor CU 501 via the DU function unit 572 of the mobile IAB node 570. If the IAB node 570 has some child IAB nodes, the child IAB nodes still belong to the IAB topology 5001. In such a case, the IAB donor CU 501 has full control (via F1 and RRC connections). In any state of migration of the MT function unit 571 of the IAB node 570, the F1 donor CU 501 can thus decide to migrate the DU function unit 572 of the IAB node 570. This decision can be made regardless of whether the MT function unit 571 of the IAB node 570 has migrated to the IAB topology 5002 or the IAB topology 5003.

The reason for the DU migration is to reduce the processing load of the F1 donor CU 501. Another reason may be that the IAB node 570 has become geographically distant from the F1 donor CU 501 and approached an area where there is no Xn connection (connection through an Xn interface) between the F1 donor CU 501 and the target donor CU. After the decision to migrate the DU of the IAB node 570, the F1 donor CU 501 also needs to decide the donor CU to migrate the DU to (referred to as a target F1 donor CU).

In such a case, since there is a non-F1 terminating donor CU here, the non-F1 terminating donor CU serves as the target (migration destination) F1 donor CU. Alternatively, instead of the DU migration to the current non-F1 terminating donor CU (i.e., default selection), another target F1 donor CU may be selected. For example, suppose that the IAB node 570 is movable and its course is predictable (for example, a bus or train scenario). In such a case, the F1 donor CU 501 may recognize an appropriate target F1 donor CU that controls the cell in which the IAB node 570 will soon connect to the network. Specifically, while the non-F1 terminating donor CU for the IAB node 570 is the donor CU 502, the IAB node 570 may rapidly pass through the IAB topology 5002 controlled by the donor CU 502 without stopping. The F1 donor CU then may decide that the DU migration of the IAB node 570 should be targeted directly at the donor CU 503. By not performing DU migration to the donor CU 502 and instead performing DU migration to the donor CU 503, protocol messages for the intermediate DU migration of the IAB node 570 are avoided. During DU migration, HO of UEs served by the IAB node 570 need also be simultaneously performed. Omitting the DU migration to the donor CU 502 can thus also avoid intermediate HO of the UEs to the donor CU 502 before new DU migration and HO of the UEs to the donor CU 503.

### First Embodiment: Determination of DU Migration of mobile IAB node

FIG. 6 illustrates a sequence example of several message flows according to the present embodiment in a case where successive MT migrations of an IAB node toward a target IAB topology are performed, including configuration of control data paths. The successive MT migrations may include migration of the MT between different parent IAB nodes managed by another IAB donor CU different from the IAB donor CU serving the DU of the IAB node. In FIG. 6 (and subsequent similar diagrams), the IAB node may be referred to as "mIAB".

FIG. 6 illustrates an IAB node 601 that may be a mobile IAB node like the IAB node 570 of FIG. 5. The IAB node 601 includes an MT function unit 603 (hereinafter, referred to as mIAB-MT 603) and a DU function unit 602 (hereinafter, referred to as mIAB-DU 602).

In FIG. 6, a source non-F1 terminating donor CU 605 terminates an RRC connection with the IAB node 601 via the mIAB-MT 603, and an F1 terminating donor CU 604 terminates an F1 connection with the IAB node 601 via the mIAB-DU 602. This sequence procedure demonstrates that a target non-F1 donor CU 606 becomes a new non-F1 terminating donor CU of the IAB node 601. For example, the correspondence with the IAB communication system of FIG. 5 is as follows. The F1 terminating donor CU 604 of the IAB node corresponds to the donor CU 501. With the MT function unit 571 of the IAB node 570 migrated to the IAB topology 5002 managed by the donor CU 502, the source non-F1 terminating donor CU 605 corresponds to the donor CU 502. When the IAB node moves toward the IAB topology 5003, the IAB node 560 is identified as a target IAB node to which the MT of the mobile IAB node 570 can be migrated. The target non-F1 terminating donor CU 606 thus corresponds to the donor CU 503.

In sequence 600, a control path (F1-C) and a user path (F1-U) are predicated on using one or more backhaul paths through the IAB topology controlled by the source non-F1 donor CU 605. In this case, the control path (F1-C) and the user path (F1-U) are ones initially set by the F1 donor CU 604 for connection to the IAB node 601. The assumed IAB topology is controlled by the source non-F1 donor CU 605 via a donor DU not illustrated in FIG. 6. For example, referring to FIG. 5, the donor CU 605 and the IAB nodes 540 and 550 may be included in one of such backhaul paths.

In the initial part of the sequence, a procedure for migrating the mIAB-MT 603 from the source non-F1 donor CU 605 to the target non-F1 donor CU 606 and the configuration of a new path for RRC protocol messages will be described.

Suppose that the non-F1 donor CU 605 receiving a measurement report S611 from the IAB node 601 starts successive MT migrations of the IAB node 601 to another IAB topology. In the example illustrated in FIG. 5, this corresponds to the case where the MT function unit 571 of the mobile IAB node 570 is migrated from the parent IAB node 550 in the IAB topology 5002 to the new parent IAB node 560 in another IAB topology 5003.

The measurement report S611 is received by the non-F1 donor CU 605 via an F1 message UL RRC MESSAGE TRANSFER (specified in TS 38.423). This F1 message is transmitted from the parent IAB node of the IAB node 601 (for example, the parent IAB node 550 in FIG. 5). The measurement report transmitted from the mIAB-MT 603 to the DU part of the parent IAB node is embedded in the RRC message. The measurement report is a result of measurement on signals received from one or more target cells, such as synchronization signal blocks (SSBs) transmitted in the serving cell and target cells. The measurement is periodically performed by the mIAB-MT 603. A target cell may be a neighboring cell of the providing cell or source cell (current serving cell). When the IAB-MT 603 detects at least one SSB that satisfied predetermined criteria (for example, received power exceeding a threshold defined in advance), a measurement report is generated/transmitted. This can provide radio link quality information about different cells near the IAB node 601. Identification information about each cell is included in the measurement report, so that the non-F1 donor CU 605 can identify the target donor CU associated with the cell. The identity of a donor CU can be inferred from physical cell identity broadcast in each cell and a new radio cell global ID managed by this donor CU and also broadcast in each cell. Here, the physical cell identity is Physical Cell Identity (PCI), and the radio cell global ID is NR Cell Global Identity (NCGI). NCGI is broadcast using a System Information Block (SIB) message. PCI or NCGI may be reported by the IAB node 601 using the measurement report 611.

Based on the received measurement report, the non-F1 donor CU 605 may detect that the IAB node 601 has received a radio signal in the target cell of the target parent IAB node with higher quality than in the source serving cell. Assume now a target parent IAB node belonging to another IAB topology (for example, the IAB node 560 in FIG. 5) as the source parent IAB node. In such a case, the source non-F1 donor CU 605 may decide to apply the inter-CU topology adaptation procedure to the IAB node 601. The target parent IAB node in the target IAB topology includes a new donor DU to route packets. The target parent IAB node may be an IAB node or an IAB donor DU.

The migration of the mIAB-MT 603 is triggered by Handover Request Acknowledge (step S612) described in TS 38.423 V 17.2.0 section 8.2.1. In step S612, the source non-F1 donor CU 605 transmits a HANDOVER REQUEST message including necessary information associated with the mIAB-MT 603 to the target non-F1 donor CU 606 so that an HO can be performed. For example, the message includes the identification information about the target cell to which the IAB node 601 switches, whereby the target parent IAB node that controls the target cell is identified. The target non-F1 donor CU 606, after requesting UE context setup of the IAB node 601 from the target parent IAB node, performs admission control. The target non-F1 donor CU 606 then provides the source non-F1 donor CU 605 with new RRC setting information along with the HANDOVER REQUEST ACKNOWLEDGE message.

In step S613, the source non-F1 donor CU 605 can relay RRC configuration information to the mIAB-MT 603 via an RRC reconfiguration message. Specifically, the RRC configuration information is first embedded in UE CONTEXT MODIFICATION REQUEST, an F1 message specified in TS 38.473, and transmitted by the non-F1 donor CU 605 to the parent IAB node of the IAB node 601. This parent IAB node then transmits an RRC reconfiguration message to the mIAB-MT 603 (step S613). The RRC reconfiguration message includes address information such as the identification address (i.e., IP address) of the target donor DU of the packet routing.

### Migration Determination Processing for IAB Node DU Function Unit

Now, a method of the present proposal will be described, in which whether to migrate the connection source IAB donor CU for the DU function unit 602 is determined with a request for the mobile IAB node 601 to hand over the MT function unit 603 as a trigger.

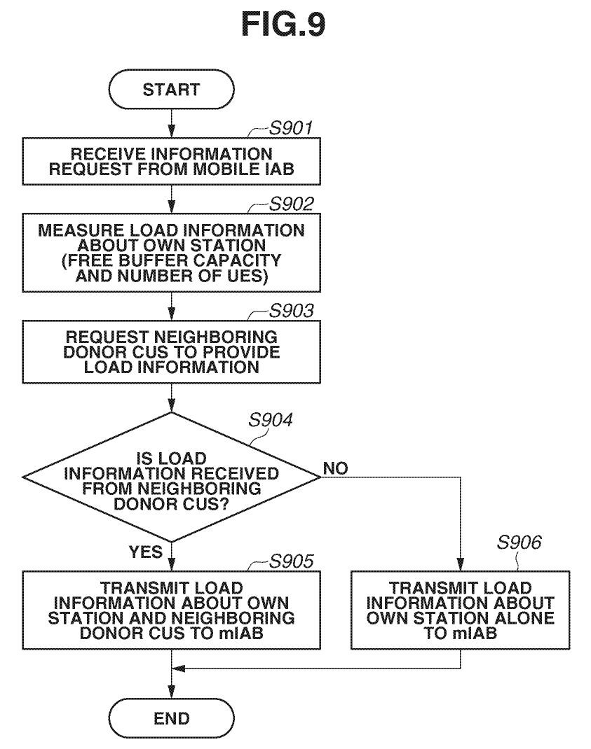

The mobile IAB node 601 receiving the migration (HO) request S613 for the mIAB-MT 603 from the source non-F1 donor CU 605 operates as follows. In step S614, the mobile IAB node 601 calculates a latency time for the F1 donor CU 604 establishing the F1 connection with the DU function unit 602 from a ping value, the number of MT migrations (hops), or the like. In step S615, the mobile IAB node 601 then requests the F1 donor CU 604 and the non-F1 donor CU 605 to provide load information about the donor CUs. FIG. 9 illustrates a flowchart of information collection processing by the requested donor CUs. Step S901 represents reception of the request for load information from the same mobile IAB node 601 as in step S615.

In step S902, the non-F1 donor CU 605 receiving the request to provide load information from the mobile IAB node 601 measures/collects the free buffer capacity of the own station, the number of connected UEs, and the like. In steps S616 and S903, the non-F1 donor CU 605 also requests neighboring donor CUs to provide load information like that of the own station. In step S617, receiving this request, neighboring donor CUs may provide their load information to the non-F1 donor CU 605 if possible. In step S904, if the non-F1 donor CU 605 receives load information from neighboring donor CUs, then in steps S618 and S905, the non-F1 donor CU 605 transmits the load information about the own station and the received load information about the neighboring donors to the requesting mobile IAB node 601. If no load information is received from neighboring donor CUs, then in S906, the non-F1 donor CU 605 provides the load information about the own station alone to the mobile IAB node 601. While the operation of the non-F1 donor CU 605 requested to provide load information has been described here, the F1 donor CU 604 requested to provide load information may operate similarly. Here, in step S616, the mobile IAB node 601 substantially requests the donor CU (target non-F1 donor CU 606) neighboring the non-F1 donor CU 605 to provide load information, via the non-F1 donor CU 605. However, the mobile IAB node 601 may directly request the donor CU (target non-F1 donor CU 606) neighboring the non-F1 donor CU 605 to provide load information.

In step S619, the mobile IAB node 601 then determines whether to migrate the connection source IAB donor CU serving as the parent node of the DU function unit 602, based on the flowchart to be described below. If the connection source IAB donor CU is determined to be migrated, then in step S620, the mobile IAB node 601 notifies the connected IAB donor CU (in this example, the F1-connected F1 donor CU 604) of the wish for DU migration (migration request). In step S619, the parent node for the mIAB-DU 602 to migrate to may be selected, in which case the mobile IAB node 601, in step S620, notifies of the migration destination IAB donor CU (in this example, the target non-F1 donor CU 606).

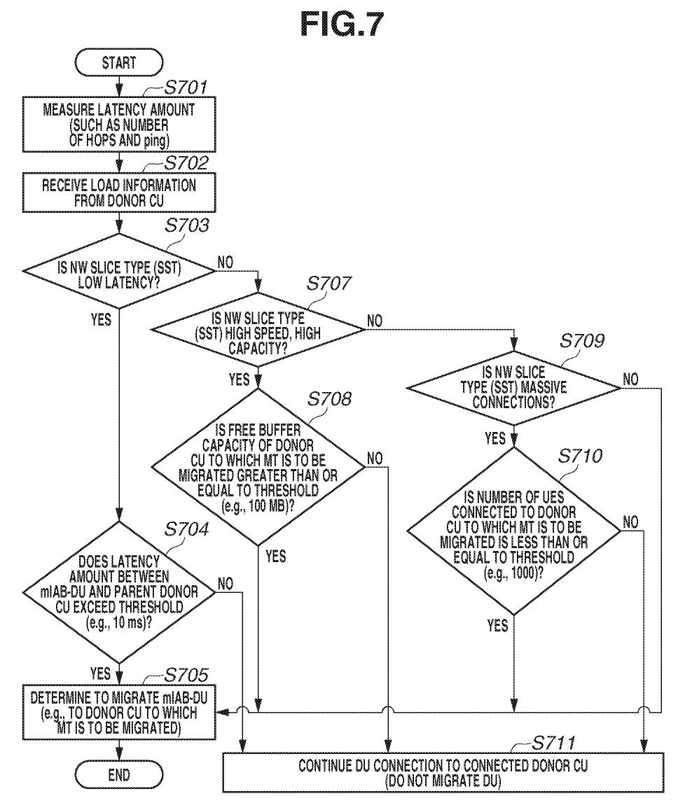

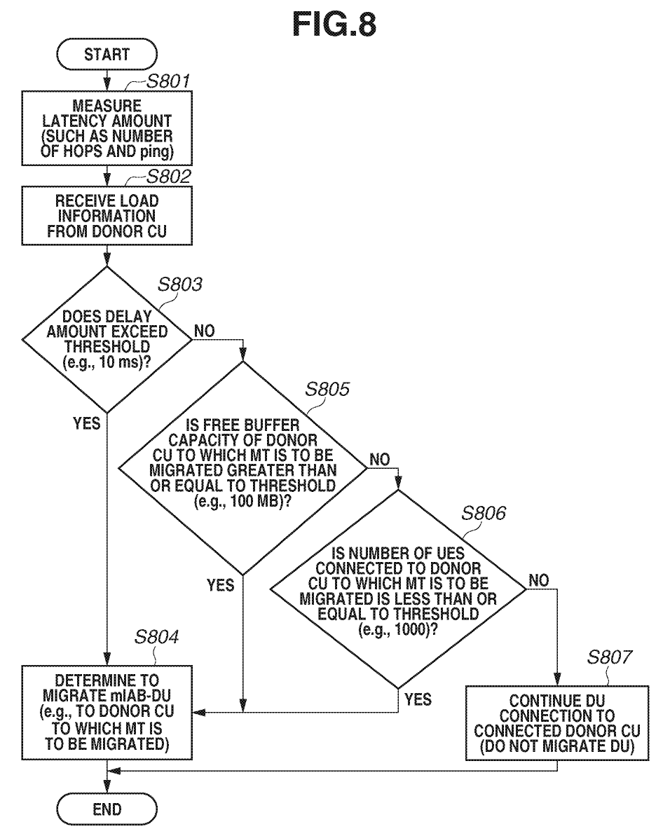

FIG. 7 illustrates the flowchart for the mobile IAB node 601 to determine whether to migrate the connection source IAB donor CU serving as the parent node of the DU function unit 602. FIG. 7 illustrates a case where a network slice request is given from a UE accessing the mobile IAB node 601. A case where no network slice request is given from UEs is illustrated in FIG. 8, a description of which will be omitted since the control method is similar to that of FIG. 7 except for the determination of the network slice type.

In step S701, to ascertain the communication conditions of the own station, the mobile IAB node 601 initially calculates a latency time for the F1 donor CU 604 establishing the F1 interface with the DU function unit 602, based on a ping value, the number of MT migrations, and the like. In step S702, the mobile IAB node 601 receives the load information about the donor CU(s), requested of the non-F1 donor CU 605. In step S703, the mobile IAB node 601 determines whether the network slice type requested by the UE is low latency. If the network slice type is low latency, then in step S704, the mobile IAB node 601 determines whether the latency time measured by the mobile IAB node 601 exceeds a threshold (for example, 10 ms or less). If the latency time exceeds the threshold, then in step S705, mobile IAB node 601 determines to migrate the DU function unit 602 from the connected F1 donor CU 604. The reason is that hopping across multiple IAB donors, as with successive MT migrations, is considered one of the factors contributing to increased latency. Here, the mobile IAB node 601 may determine to migrate the mIAB-DU 602 to the target non-F1 donor CU 606 to which the mIAB-MT 603 is to be migrated. If, in step S704, the latency time does not exceed the threshold, then in step S711, the mobile IAB node 601 determines to not migrate the mIAB-DU 602. If, in step S703, the network slice type request by the UE is not low latency, then in step S707, the mobile IAB node 601 determines whether the network slice type is high speed, high capacity. If the network slice type is high speed, high capacity, then in step S708, the mobile IAB node 601 checks whether the free buffer capacity of the target non-F1 donor CU 606 is greater than or equal to a threshold (for example, 100 MB). If the free buffer capacity is greater than or equal to the threshold, then in step S705, the mobile IAB node 601 determines to migrate the mIAB-DU 602 from the connected F1-donor CU 604. Here, the mobile IAB node 601 may further determine migration to the target non-F1 donor CU 606 with sufficient buffer capacity. On the other hand, if, in step S708, the free buffer capacity of the target non-F1 donor CU 606 is not greater than or equal to the threshold, then in step S711, the mobile IAB node 601 determines to not migrate the mIAB-DU 602.

If, in step S707, the network slice type requested by the UE is not high speed, high capacity, then in step S709, the mobile IAB node 601 determines whether the network slice type is massive connections. If, in step S709, the network slice type is not massive connections, then in step S705, the mobile IAB node 601 determines to migrate the mIAB-DU 602 from the connected F1 donor CU 604. If the network slice type is massive connections, then in step S710, the mobile IAB node 601 checks whether the number of connected UEs is less than or equal to a threshold (for example, 1000). If the number of connected UEs is less than or equal to the threshold, then in step S705, the mobile IAB node 601 determines to migrate the mIAB-DU 602 from the connected F1 donor CU 604. Here, the mobile IAB node 601 may determine to migrate the mIAB-DU 602 to the target non-F1 donor CU 606 with not many UEs connected. On the other hand, if, in step S710, the number of connected UEs is not less than or equal to the threshold, then in step S711, the mobile IAB node 601 determines to not migrate the mIAB-DU 602.

A sequence of the migration procedure where the mIAB-DU 602 is migrated to the target non-F1 donor CU 606 may be as follows. The IAB node 601 performs a random access procedure on the target parent IAB node (for example, the IAB node 560 in FIG. 5). In step S621, the IAB node 601 then transmits an RRC reconfiguration completion message (S621) to the target non-F1 donor CU 606. The RRC reconfiguration completion message is transmitted via the target parent IAB node and an F1 message UL RRC MESSAGE TRANSFER in which RRC Reconfiguration Complete is embedded.

A procedure S640 ends with an Xn message UE CONTEXT RELEASE (step S622) specified in TS 38.423, transmitted from the target non-F1 donor CU 606 to the source non-F1 donor CU 605. Note that the source non-F1 donor CU 605 retains the IDs of the F1 donor CU 604 and the IAB node 601. The F1 paths of the IAB node 601 can still be used through the IAB topology controlled by the source non-F1 donor CU 605.

The procedure S640 and a procedure S650 relate to procedures for updating the F1 paths (F1-C and F1-U) between the IAB node 601 and the F1 donor CU 604 via the target donor DU in the IAB topology controlled by the target non-F1 donor CU 606. As an outline of the operation of the procedure S650, the source non-F1 donor CU 605 changes the path setting of the F1 user plane transport to the target non-F1 donor CU 606. Note that this processing is a series of path switching procedures triggered by the mIAB-MT Handover Request/Acknowledge in step S612.

The target non-F1 donor CU 606 sets up a BH RLC channel and a BAP layer routing entry in the target path between the target parent IAB node of the IAB node 601 and the target IAB donor DU. In the example illustrated in FIG. 5, the target parent IAB node corresponds to the IAB node 560, and the target IAB donor DU corresponds to the IAB donor DU 507. The target non-F1 donor CU 606 can establish additional BH RLC channels and BAP configuration for the IAB-MT under migration via an RRC message (S623).

Next, the DU unit (mIAB-DU 602) of the IAB node 601 transmits a DU configuration message (S624) to the F1 donor CU 604. As described above, this message may be the F1 message gNB-DU CONFIGURATION UPDATE. This message includes the ID of the target non-F1 donor CU 606 and the ID of the F1-C and F1-U traffic target donor DU. This enables the F1 donor CU 604 to acquire the ID of the target non-F1 donor CU 606. In other words, the IAB node 601 reports the PCI or NCGI of the target cell managed by the target non-F1 donor CU 606 to the F1 donor CU 604. After the reception of the message (S613), addresses such as the IP address of the target donor DU are recognized by the IAB node 601. The destination address of the message (S624) is the F1 donor CU 604. Once the target donor DU in the IAB topology controlled by the target non-F1 donor CU 606 receives this IP packet, the IP packet can be routed through the wired backhaul to the F1 donor CU 604. Receiving the ID of the target donor DU, the F1 donor CU 604 can update the configuration so that F1 packets are distributed to the IAB node 601 via the target donor DU in the IAB topology 5003. For example, the F1 donor CU 604 can update the routing path associated with the IAB node based on the received information. The F1 control data (F1-C) path is then updated.

Here, as an alternative option to notifying the F1 donor CU 604 of the ID of the target non-F1 donor CU 606 in step S620, the following method may be used. The source non-F1 donor CU 605 may execute the procedures represented by Configuration Update (message in step S628) and Configuration Update Response (message in step S630). This can provide similar information. The message (S628) transmitted by the source non-F1 donor CU 605 may include the ID of the target non-F1 donor CU 606. The message (S630) may be an acknowledgment from the F1 donor CU 604. The donor CU ID is specified together with an information element called Global NG-RAN Node ID in TS 38.423 V 17.2.0 section 9.2.2.3.

In one example, the message (S628) may be an IAB TRANSPORT MIGRATION MODIFICATION REQUEST message. The message (S630) may be an IAB TRANSPORT MIGRATION MODIFICATION RESPONSE. Both are messages specified in TS 38.423 V 17.2.0 (Xn protocol) sections 9.1.4.4 and 9.1.4.5, and used in the IAB Transport Migration Modification procedure. Using this procedure, the source non-F1 donor CU 605 can notify the F1 donor CU 604 to release traffic offloaded through the IAB topology controlled by the source non-F1 donor CU 605.

In another example, the message in step S628 may be an NG-RAN NODE CONFIGURATION UPDATE message. Moreover, the message in step S630 may be an NG-RAN NODE CONFIGURATION UPDATE ACKNOWLEDGE. Both are messages specified in TS 38.423 V 17.2.0 (Xn protocol) sections 9.1.3.4 and 9.1.3.5, and used in the NG-RAN node configuration update procedure. This message has the following features to enable the F1 donor CU 604 to identify the IAB node 601 under migration associated with the received message. That is, this message indicates that the IAB node has migrated from the IAB topology managed by the source non-F1 donor CU 605 to the target IAB topology managed by the target non-F1 donor CU 606 (new non-F1 donor CU). Moreover, one or more new paths are used for the routing data of the IAB node under migration via the topology of the target non-F1 donor CU 606. The message transmitted to the F1 donor CU 605 includes the ID of the IAB node under migration associated with each of the non-F1 donor CU-controlled IAB topologies. For example, in these procedures (NG-RAN node configuration update and IAB transport migration modification), the ID of the IAB node 601 is present in all messages having information elements. F1-Terminating IAB-donor UE XnAP ID and non-F1-Terminating IAB-donor UE XnAP ID. Both are defined during the initial MT migration of the IAB node 601 to the first non-F1 donor CU controlled IAB topology (F1 donor CU 604 and source non-F1 donor CU 605). During the successive MT migration of the IAB node 601 to the second non-F1 donor CU controlled IAB topology (target IAB topology), the target non-F1 donor CU 606 assigns an ID to the IAB node 601. This is shared with the source non-F1 donor CU 605 in a HANDOVER REQUEST ACKNOWLEDGE message including the target NG-RAN node UE XnAP ID information element.

According to the present embodiment described above, a DU migration request can be notified when the mobile IAB node determines MT migration and communication conditions deteriorate due to a change in the connection path between the IAB donor and the DU of the mobile IAB node. This enables path switching to an appropriate IAB donor CU.

### Second Embodiment

The first embodiment has dealt with a method in which the mobile IAB node 601 determines whether to migrate the source IAB donor CU of the DU function unit 602, with an HO request for the MT function unit 603 as the trigger. In contrast, in the present embodiment, the migration of the DU function unit 602 is determined with speed information about the mobile IAB node 601 as a trigger, independent of the HO request for the MT function unit 603.

For example, in the sequence of FIG. 6, in the absence of the operation up to the HO request for the MT function unit 603 in step S613, the migration of the DU function unit 602 may be determined with the speed information about the mobile IAB node 601 as a trigger. More specifically, the mobile IAB node 601 may constantly measure the moving speed of the own station, and when the moving speed falls to or below a certain value (for example, 10 km/h), determines that the MT function unit 603 of the mobile IAB node 601 will not switch the parent node for a certain period of time. The mobile IAB node 601 then determines to migrate the DU function unit 602 from the connected non-F1 donor CU 605. The subsequent sequence is similar to the operation of step S614 in FIG. 6. The conditions other than the trigger may be similar to those in the first embodiment, and a description of the sequence and flowcharts will be omitted.

### Third Embodiment

The first embodiment has dealt with the method in which the mobile IAB node 601 determines whether to migrate the source IAB donor CU for the DU function unit 602, with an HO request for the MT function unit 603 as the trigger. Alternatively, a method may be used in which a migration source IAB donor CU 1105 for an MT 1103 of a mobile IAB node 1101 determines whether migration is needed, with the decision to hand over the MT function unit 1103 of the mobile IAB node 1101 as a trigger. That is, in the present embodiment, the migration source IAB donor CU 1105 determines whether a DU function unit 1102 of the mobile IAB node needs to be migrated, and notifies the mobile IAB node 1101.

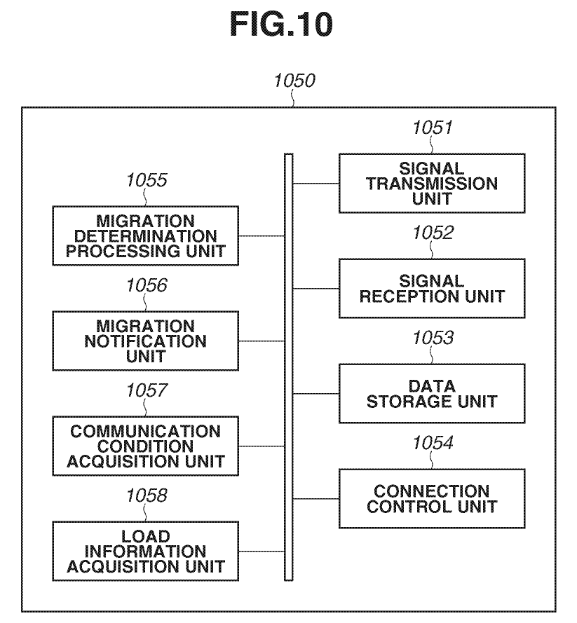

FIG. 10 is a block diagram illustrating a configuration example of software functions 1050 of an IAB donor that performs a communication control function according to the present embodiment.

The software functions 1050 of the IAB donor include a signal transmission unit 1051, a signal reception unit 1052, a data storage unit 1053, a connection control unit 1054, a migration determination processing unit 1055, a migration notification unit 1056, a communication condition acquisition unit 1057, and a load information acquisition unit 1058. The functions of the respective blocks illustrated in FIG. 10 can be implemented, in the hardware configuration illustrated in FIG. 4A, by the control unit 402 executing control programs stored in the storage unit 403.

The signal transmission unit 1051 and the signal reception unit 1052 perform radio signal transmission and reception compliant with 3GPP standards such as the LTE standard or the 5G standard.

The data storage unit 1053 retains various programs and various types of data (various types of information) by storing them in the storage unit 403.

The connection control unit 1054 controls an antenna for wireless communication performed by the wireless communication unit 404. In the present embodiment, the connection control unit 1054 determines whether the MT function unit of the mobile IAB node needs to be handed over, and decides to hand over the MT function unit as needed. Deciding to hand over the MT function unit, the connection control unit 1054 issues a migration request (HO request) for the MT function unit.

The migration determination processing unit 1055 performs determination processing based on communication conditions, the determination processing including whether to migrate the DU function unit of the mobile IAB node. The determination processing itself may be similar to the migration determination processing unit 455 according to the foregoing first embodiment. In the present embodiment, the migration determination processing unit 1055 may perform the determination processing with the HO decision made by the connection control unit 1054 as a trigger.

The migration notification unit 1056 transmits notification information about the migration to the mobile IAB node, if the migration determination processing unit 1055 determines to migrate the DU function unit of the mobile IAB node. The RRC Reconfiguration or RRC Setup message format defined in TS 38.331 section 6.2.2 may be used as the message format for transmitting the notification information. For example, fields such as "mIAB-DU migration request" and "mIAB-DU migration destination donor CU" may be added to the reserved area "nonCriticalExtension" therein.

The communication condition acquisition unit 1057 acquires communication condition information about the connected mobile IAB node. The communication condition information itself may be similar to that collected by the communication condition collection unit 457 according to the foregoing first embodiment. In the present embodiment, the communication condition acquisition unit 1057 acquires the communication condition information based on notifications from the mobile IAB node. In this case, the reserved area "nonCriticalExtension" of the Measurement Report message format defined in TS 38.331 section 6.2.2 may be used. For example, fields such as "communication information about mobile IAB node" and "network slice type requested by UE" may be added to the reserved area. In such a case, the communication information field of the mobile IAB node may include communication condition information (latency time and the like).

The load information acquisition unit 1058 acquires load information about the own station. As in the foregoing first embodiment, the load information may include free buffer capacity and the number of connected UEs. In addition to the load information about the own station, the load information acquisition unit 1058 may acquire load information about other IAB donor CUs neighboring the connected IAB donor CU.

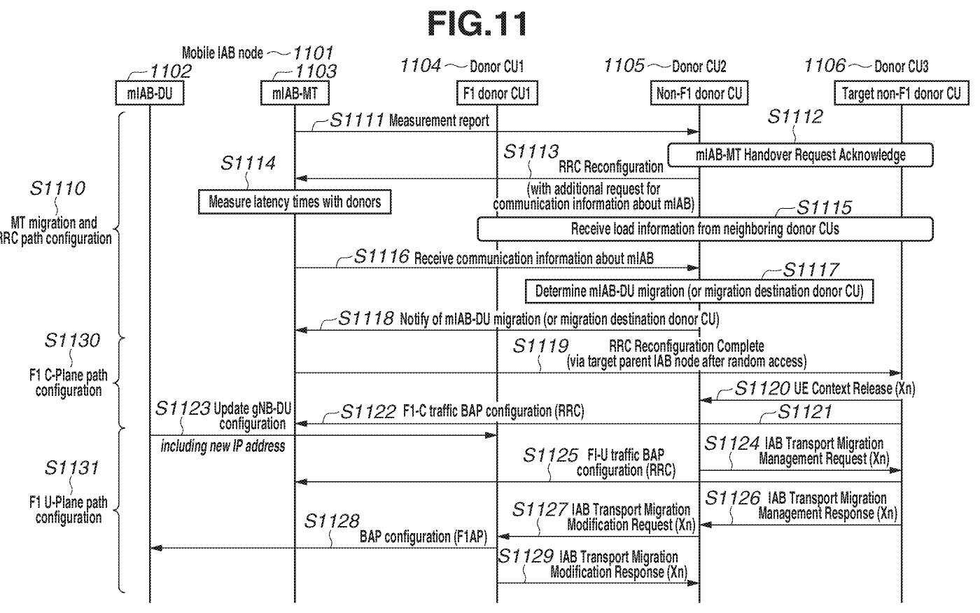

Specific sequences will be described with reference to FIG. 11. Note that the sequences are common in terms of migration determination of the DU function unit 1102 of the mobile IAB node, with the only difference in whether the entity performing the migration determination is the mobile IAB node 1101 or the IAB donor CU 1105. Therefore, only differences from FIG. 6 will be described, and a description of the same sequences will be omitted.

In step S1113, the source non-F1 donor CU 1105, after the decision to hand over the mobile IAB node MT 1103, transmits an RRC Reconfiguration message with an additional parameter for requesting communication condition information about the mobile IAB node. The mobile IAB node 1101 receiving the migration request (HO request) for the mIAB-MT 1103 from the source non-F1 donor CU 1105 performs the following operation. In step S1114, based on ping values, the number of MT migrations (hops), or the like, the mobile IAB node 1101 calculates latency times for the F1 donor CU 1104 establishing an F1 interface with the DU function unit 1102, as well as the IAB donor CU 1105.

In step S1116, the mobile IAB node 1101 transmits the measured latency time of the own station to the non-F1 donor CU 1105 as the communication condition information.

In step S1115, the non-F1 donor CU 1105, after the message transmission in step S1113, collects load information about the own station and load information about neighboring donor CUs. In step S1117, the IAB donor CU 1105, after the reception of step S1116, determines whether to migrate the mIAB-MT based on the flowchart to be described below. In step S1118, the IAB donor CU 1105 notifies the mobile IAB node of the result of determination of the DU migration.

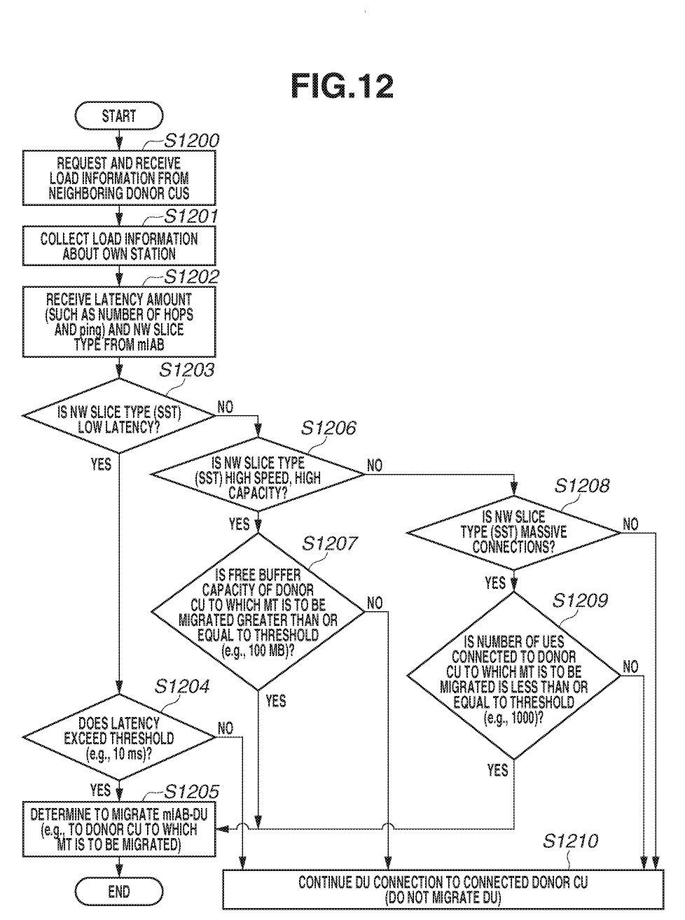

The mIAB-DU migration determination processing by the donor CU will now be described with reference to FIG. 12.

In step S1200, the non-F1 donor CU 1105 that is the migration source of the mIAB-MT initially requests neighboring donor CUs to provide load information (such as free buffer capacity and the number of connected UEs), and receives the load information from the neighboring donor CUs. In step S1201, the non-F1 donor CU 1105 measures the free buffer capacity of the own apparatus, the number of connected UEs, and the like to collect load information. In step S1202, the non-F1 donor CU 1105 receives the latency time measured by the mobile IAB node 1101and the

network slice type requested by an accessing UE. In step S1203, the non-F1 donor CU 1105 determines whether the network slice type requested by the accessing UE is low latency (URLLC). If the network slice type is low latency, then in step S1204, the non-F1 donor CU 1105 determines whether the measured latency time exceeds a threshold (for example, 10 ms or less). If the latency time exceeds the threshold, then in step S1205, the non-F1 donor CU 1105 determines to migrate the mIAB-DU 1102 from the connected non-F1 donor CU 1105, since hopping across multiple IAB donors as with successive MT migrations is considered to be one of the factors contributing to increased latency. Here, the non-F1 donor CU 1105 may further determine migration to the target non-F1 donor CU 1106 to which the mIAB-MT 1103 is to be migrated. If, in step S1204, the latency time does not exceed the threshold, then in step S1210, the non-F1 donor CU 1105 does not migrate the DU. If, in step S1203, the network slice type requested by the UE is not low latency (URLLC), then in step S1206, the non-F1 donor CU 1105 determines whether the network slice type is high speed, high capacity (eMBB). If the network slice type is high speed, high capacity, then in step S1207, the non-F1 donor CU 1105 determines whether the free buffer capacity of the target non-F1 donor CU 1106 is greater than or equal to a threshold (for example, 100 MB). If the free buffer capacity is greater than or equal to the threshold, then in step S1205, the non-F1 donor CU 1105 determines to migrate the mIAB DU 1102 from the connected non-F1 donor CU 1105. Alternatively, the non-F1 donor CU 1105 determines to migrate the mIAB-DU 1102 to the target non-F1 donor CU 1106 with sufficient buffer capacity. If, in step S1206, the network slice type requested by the UE is not high speed, high capacity, then in step S1208, the non-F1 donor CU 1105 determines whether the network slice type is massive connections (MIoT). If the network slice type is massive connections, then in step S1209, the non-F1 donor CU 1105 checks whether the number of connected UEs is less than or equal to a threshold (for example, 1000). If the number of connected UEs is less than or equal to the threshold, then in step S1205, the non-F1 donor CU 1105 determines to migrate the DU function unit 1102 from the connected non-F1 donor CU 1105. Alternatively, the non-F1 donor CU 1105 determines migration to the target non-F1 donor CU 1106 with not many UEs connected.

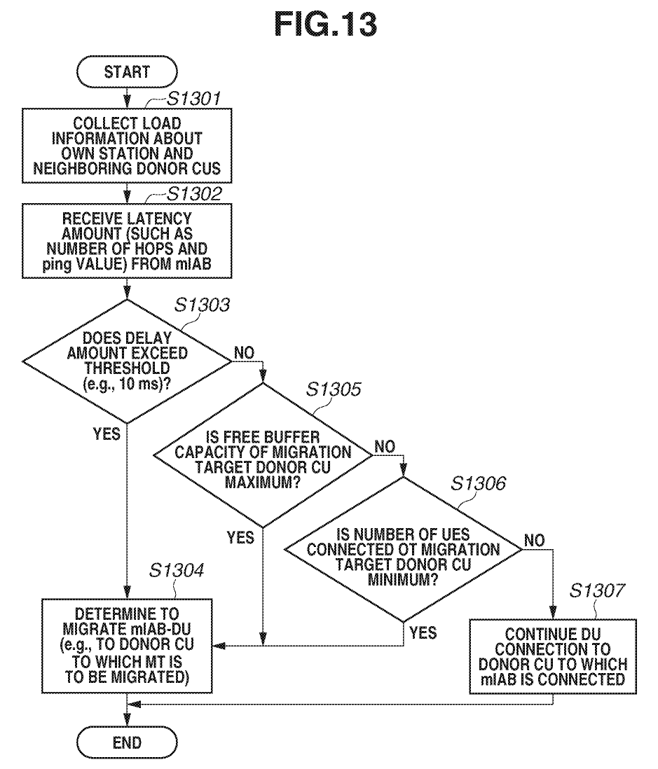

FIG. 12 illustrates the case where the network slice is requested by the UE connected to the mobile IAB node 1101. A case without a UE request is illustrated in FIG. 13, a description of which will be omitted since the control method is similar to that of FIG. 12 except for the determination of the network slice type.

### Other Embodiments

The present disclosure can also be implemented by processing for providing a program for implementing one or more functions of the foregoing embodiments to a system or an apparatus via a network or a storage medium, and reading and executing the program by one or more processors in a computer of the system or apparatus. A circuit for implementing one or more functions (such as an ASIC and an FPGA) may also be used for implementation.

Up to this point, the embodiments have been described in detail. However, the present disclosure is not limited to the specific embodiments, and various modifications and changes may be made within the scope of the claims. All or some of the components of the foregoing embodiments may also be combined.

The present disclosure is not limited to the foregoing embodiments, and various modifications and changes can be made without departing from the spirit and scope of the present disclosure. The following claims are therefore appended to make the scope of the present disclosure public.

According to an aspect of the present disclosure, a mechanism that enables migration of a Distributed Unit (DU) depending on communication conditions can be provided.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A communication apparatus configured to function as a mobile Integrated Access and Backhaul (IAB) node, the communication apparatus comprising at least one processor, wherein the at least one processor acts as units comprising:
a determination unit configured to perform determination processing based on a communication condition, the determination processing including whether to perform migration of a Distributed Unit (DU) function unit; and
a first transmission control unit configured to, in a case where the determination unit determines to perform the migration, transmit notification information related to the migration to a connected IAB donor Central Unit (CU).

2. The communication apparatus according to claim 1, wherein the at least one processor further acts as units comprising:
a reception control unit configured to receive a handover request for a Mobile Termination (MT) function unit from the connected IAB donor CU,
wherein the determination unit is configured to perform the determination processing with reception of the handover request by the reception control unit as a trigger.

3. The communication apparatus according to claim 1, wherein the determination unit is configured to, in a case where moving speed of an own station falls to or below a threshold, perform the determination processing.

4. The communication apparatus according to claim 1, wherein the at least one processor further acts as units comprising:
a collection unit configured to collect communication condition information including at least one of a latency time related to communication with the connected IAB donor CU and a network slice type requested by a user equipment (UE) accessing the communication apparatus,
wherein the determination unit is configured to determine the communication condition based on the communication condition information collected by the collection unit.

5. The communication apparatus according to claim 1, wherein the at least one processor further acts as units comprising:
a request unit configured to request from the connected IAB donor CU at least one of load information about the connected IAB donor CU and load information about another IAB donor CU neighboring the connected IAB donor CU,
wherein the determination unit is configured to determine the communication condition based on the load information acquired via a request by the request unit.

6. The communication apparatus according to claim 5, wherein the request unit is configured to use a Radio Resource Control (RRC) message to request the load information.

7. The communication apparatus according to claim 1, wherein the determination processing includes deciding a migration destination IAB donor CU in a case where the migration is determined to be performed.

8. The communication apparatus according to claim 1, wherein the notification information includes a request for the migration.

9. The communication apparatus according to claim 1, wherein the at least one processor further acts as units comprising:
a notification control unit configured to notify the connected IAB donor CU of an identifier of the migration destination IAB donor CU, using an F1 Application Protocol (F1-AP) message.

10. A communication apparatus configured to function as an IAB donor CU, the communication apparatus comprising at least one processor, wherein the at least one processor acts as units comprising:
a determination unit configured to perform determination processing based on a communication condition, the determination processing including whether to perform migration of a DU function unit of a mobile IAB node; and
a notification unit configured to, in a case where the determination unit determines to perform the migration, transmit notification information about the migration to the mobile IAB node.

11. The communication apparatus according to claim 10, wherein the at least one processor further acts as units comprising:
a decision unit configured to decide a handover of an MT function unit of the mobile IAB node,
wherein the determination unit is configured to perform the determination processing with a decision of the handover by the decision unit as a trigger.

12. The communication apparatus according to claim 10, wherein the at least one processor further acts as units comprising:
a first acquisition unit configured to acquire communication condition information from the mobile IAB node, the communication condition information including at least one of a latency time related to communication with a connected IAB donor CU of the mobile IAB node and a network slice type requested by a UE accessing the mobile IAB node,
wherein the determination unit is configured to determine the communication condition based on the communication condition information acquired by the first acquisition unit.

13. The communication apparatus according to claim 10, wherein the at least one processor further acts as units comprising:
a second acquisition unit configured to acquire at least one of load information about an own station and load information about another IAB donor CU neighboring the own station.

14. The communication apparatus according to claim 13, wherein the determination unit is configured to determine the communication condition based on the load information acquired by the second acquisition unit.

15. The communication apparatus according to claim 10, wherein the determination processing includes deciding a migration destination IAB donor CU in a case where the migration is determined to be performed.

16. The communication apparatus according to claim 10, wherein the notification information includes a request for the migration.

17. The communication apparatus according to claim 10, wherein the notification unit is configured to use an RRC message to transmit the notification information about the migration.
